(19) United States
(12) Patent Application Publication
(10) Pub. No.: US 2007/0043155 A1
(43) Pub. Date: Feb. 22, 2007

(54) Olefinic thermoplastic polymer compositions with fillers of nanometer scale in the form of masterbatches

(76) Inventor: Bernard Pees, Beaumontel (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/556,758

(22) PCT Filed: May 13, 2004
(86) PCT No.: PCT/FR04/01168

§ 371 Date: Nov. 9, 2006

(30) Foreign Application Priority Data
Jun. 16, 2003 (FR) 03/05872

(51) Int. Cl. C08K 3/34

(52) U.S. Cl. 524/445

(57) ABSTRACT

The invention relates to thermoplastic polymer compositions in the form of masterbatches, comprising a matrix of an olefinic copolymer obtained from olefinic monomers and at least one alkyl(meth)acrylate monomer, in which exfoliable organophilefilelrs of the lamellar type are dispersed, such as silicates, characterized in that after complete dispersion, the fillers are of nanometer scale with a content of at least 20% by weight with relation to the composition. The invention is further of application for the production of polymeric materials particularly of the polyethylene type, with fillers, the thermomechanical and barrier properties of which are improved.

This application claims benefit, under U.S.C. § 119 or §365 of French Application Number 03.05872, filed May 16, 2003; and PCT/FR2004/001168 filed May 13, 2004.

### FIELD OF THE INVENTION

The present invention relates to thermoplastic polymer compositions in the form of masterbatches, comprising a matrix consisting of an olefin copolymer, obtained from olefin monomers, especially of the ethylene or propylene type, and from at least one alkyl (meth)acrylate monomer, in which matrix exfoliable organophilic fillers of the lamellar type, such as silicates and especially treated clays, are dispersed.

### BACKGROUND OF THE INVENTION

It is well known to use the technology of the intercalation of various chemical compounds, and in particular of quaternary ammonium salts and nitrogen-containing organic surfactant compounds, between the sheets of fillers such as clays, giving them swelling properties in organic liquids with low shear rates, and in particular the use disclosed by document EP0133071.

An additional step has been overcome in obtaining mineral fillers of lamellar structure, such as clays treated (intercalated) by various polymers, such as polyvinyl alcohol (PVA) or polyacrylic acid, as described in the document U.S. Pat. No. 5,552,469, or by polyvinylpyrrolidon (PVP), or polyesters such as polyethylene terephthalate (PET) as described in the document U.S. Pat. No. 5,578,672. A sufficient quantity of polymer is adsorbed between the sheets of these clays so as to space them apart by about 10 to 55 angstroms. These fillers can then be incorporated into matrices consisting of thermoplastic polymeric materials, such as polyamides or polyesters, and, after compounding, they may be exfoliated (or finely dispersed), as described in the document U.S. Pat. No. 5,760,121.

The specific treatment of these fillers allows them to be completely exfoliated, that is to say these fillers are reduced to the state of individual molecular sheets, the thickness of which is of the order of the magnitude of a few nanometers (i.e. a few tens of angstroms) or tens of nanometers. The extremely fine dispersion of these fillers in the form of nanoparticles (or nanofillers) confers on the materials thus obtained, which are called “nanocomposites,” mechanical, thermal or optical properties that are superior to those of these polymeric materials when unfilled or filled with conventional fillers, such as for example talc.

Studies relating to nanocomposite ethylene-vinyl acetate (EVA) copolymers are also found in the literature, in particular in the publication by Professor P. Dubois (Macromol. Rapid Communication 2001, 22, 643-646) or in the publication by Professor R. Mulhaupt (Polymer, 2001, 42, 4501-4507). However, a serious problem encountered is to how to disperse these fillers at high concentrations in apolar polymers, such as polyolefins and in particular polyethylene (PE) and polypropylene (PP).

Document WO 99/07790 discloses a nanocomposite material comprising a polymeric matrix that may be a polyolefin, a clay and an agent for intercalating the clay, composed of a multiblock copolymer having structural units (A) compatible with the clay and structural units (B) compatible with the matrix. The maximum level of introduction of this clay treated by a copolymer having a polyethyleneimine block into polyethylene is 5% by weight.

Document U.S. Pat. No. 6,407,155 discloses the treatment of clays by a coupling agent of the silane type and co-intercalation of onium ions and of a polymer, and the formation of nanocomposite compositions comprising at least 60% by weight of said polymer as matrix and at most 40% by weight of the treated clay. The incorporation of the treated clay into polypropylene and its exfoliation require the addition of a small amount of maleic-anhydride-modified polypropylene.

Likewise, document US 2001/0033924 Al discloses a concentrated nanocomposite composition comprising a filler of the treated montmorillonite clay type mixed with a polymeric olefin matrix. The only polymers exemplified are maleic-anhydride-modified polypropylenes. In the field of fire-retardant formulations for cables, the use of polymer compositions of the EVA (ethylene-vinyl acetate copolymer) type and of PE (polyethylene)/EVA blends with fillers of the nanoscale organophilic clay type is disclosed by patent applications WO 00/66657 and WO 00/68312, respectively. However, the content of fillers incorporated into the polymers is low (a maximum of 5% by weight).

Patent U.S. Pat. No. 6,117,932 discloses a “resin composite” comprising an organophilic clay, which is modified by ionic bonding with an organic onium ion, and a polymer, this polymer possessing a functional group having a strong affinity for this clay. One formulation obtained by the melt-blending in an extruder of an ethylene/methyl methacrylate copolymer with an organophilic clay allows articles to be obtained that possess improved mechanical properties (especially an increase in the elastic modulus). The content of filler introduced into the resin does not exceed 5% by weight (expressed as ash content).

Patent application WO 00/40404 discloses the use of aqueous compositions of polymeric binders of the ethylene/acrylic acid or ethylene/alkyl acrylate copolymer type, which compositions are blended with nanoscale fillers (or nanofillers) chosen from silicates and clays, as surface coatings for thermoplastic polyolefin films. The resulting films obtained possess improved gas impermeability properties. These aqueous polymeric compositions have low filler contents (<9% by weight) and cannot be melt-blended with non-polar olefin polymers such as polyethylene (PE) or polypropylene (PP).

Moreover, patent application EP 1 076 077 discloses a composition comprising, as a blend, a polyamide resin, a functionalized polyolefin, such as an ethylene/butyl acrylate/maleic anhydride copolymer, and a filler of the intercalated silicate type, the mechanical properties and the dimensional stability of which are good. The filler content is only 3% in the functionalized polyolefin.

Moreover, document WO 02/066553 discloses a process for manufacturing an article from a blend of a polyolefin and of a nanocomposite masterbatch comprising from 0 to 99% by weight of polyolefin (polypropylene), from 1 to 100% by weight of functionalized polyolefin (maleic-anhydride-modified polypropylene) and from 10 to 50% by weight of an organically modified clay. This masterbatch necessarily contains a functionalized polyolefin and its filler content does not exceed 50% by weight.

It has now been discovered that unfunctionalized olefin copolymers or polyolefins, that is to say not having reactive units (functional groups), such as in particular acid, anhydride or epoxy functional groups, can be highly filled with organophilic clay, in particular in the form of masterbatches, while still exhibiting a perfect state of exfoliation and dispersion of this clay. These masterbatches serve surprisingly as a carrier for incorporating relatively high contents of perfectly exfoliated fillers with a uniform dispersion in polyolefins such as polyethylene or polypropylene, without requiring high shear rates, and still conferring on them various improved properties, such as in particular tensile mechanical properties (elastic modulus and elongation at break) and thermomechanical properties.

Furthermore, the materials obtained from the nanofilled polymer compositions according to the invention exhibit high barrier properties with respect to fluids, that is to say a reduced permeability with respect to said fluids, which may be gases such as O₂ and CO₂, water vapor or liquids.

### SUMMARY OF THE INVENTION

The present invention relates to thermoplastic polymer compositions in the form of masterbatches, comprising a matrix consisting of an olefin copolymer or polyolefin, obtained from olefin monomers and from at least one alkyl (meth)acrylate monomer, in which matrix exfoliable organophilic fillers of the lamellar type, such as silicates, are dispersed, characterized in that said fillers after complete dispersion are of nanoscale size and in that their content is at least 20% by weight relative to the composition.

Preferably, in these thermoplastic polymer compositions, the olefin copolymer comprises:

60 to 98% by weight of olefin comonomer; and

2 to 40% by weight of alkyl (meth)acrylate comonomer.

### BRIEF DESCRIPTION OF THE DRAWINGS

The Figures are all Transmission Electron Microscopy (TEM) micrographs of compositions of the Examples:

FIG. 1 is a micrograph of Example 1.

FIG. 2 is a micrograph of Example 2.

FIG. 3 is a micrograph of Example 3.

FIG. 4 is a micrograph of Example 4.

FIG. 5 is a micrograph of Example 5.

FIG. 6 is a micrograph of Example 6.

FIG. 7 is a micrograph of a commercial masterbatch based on NANOMER C.30PE-type polyethylene.

FIG. 8 is a micrograph of Example 7.

FIG. 9 is a micrograph of Example 8.

FIG. 10 is a micrograph of Comparative Example 9.

FIG. 11 is a micrograph of Example 8 at 140,000×magnification.

FIG. 12 is a micrograph of Example 10.

FIG. 13 is a micrograph of Example 10.

### DETAILED DESCRIPTION OF THE INVENTION

An unfunctionalized polyolefin is conventionally a homopolymer or a copolymer of alpha-olefins or of diolefins, such as for example:
alpha-olefins, advantageously those having from 3 to 30 carbon atoms, which include polypropylene, 1-butene, 1-pentene, 3-methyl-1-butene, 1-hexene, 4-methyl-1-pentene, 3-metlhyl-1-pentene, 1-octene, 1-decene, 1-dodecene, 1-tetradecene, 1-hexadecene, 1-octadecene, 1-eicocene, 1-dococene, 1-tetracocene, 1-hexacocene, 1-octacocene and 1-triacontene. These alpha-olefins may be used individually or as a mixture of two or more of them;
polyethylene homopolymers and copolymers, in particular high-density polyethylene (HDPE), low-density polyethylene (LDPE), linear low-density polyethylene (LLDPE), very low-density polyethylene (VLDPE) and metallocene polyethylene, that is to say polymers obtained by the copolymerization of ethylene with an alpha-olefin, such as propylene, butene, hexene or octene in the presence of a single-site catalyst generally consisting of a zirconium or titanium atom and of two alkyl cyclic molecules linked to the metal. More specifically, the metallocene catalysts are usually composed of two cyclopentadiene rings linked to the metal. These catalysts are frequently used with aluminoxanes as cocatalysts or activators, preferably methylaluminoxane (MAO). Hafinium may also be used as the metal to which the cyclopentadiene is attached. Other metallocenes may include transition metals of Groups IVA, VA and VIA. Metals from the lanthanide series may also be used:
dienes, such as for example 1,4-hexadiene;
propylene homopolymers or copolymers;
ethylene/alpha-olefin copolymers, such as ethylene/propylene copolymers, ethylene-propylene-rubber (EPR) and ethylene/propylene/diene monomer (EPDM) elastomers;
blends of polyethylene with an EPR or an EPDM;
styrene/ethylene-butene/styrene (SEBS), styrene/butadiene/styrene (SBS), styrene/iso-prene/styrene (SIS) and styrene/ethylene-propylene/styrene (SEPS) block copolymers; and
copolymers of ethylene with at least one product chosen from salts or esters of unsaturated carboxylic acids, such as alkyl (meth)acrylates (for example methyl acrylate), or vinyl esters of saturated carboxylic acids, such as vinyl acetate (EVA) or vinyl propionate, the proportion of comonomer possibly reaching 40% by weight.

Examples that may be mentioned include ethylene copolymers, such as copolymers obtained by high-pressure radical polymerization of ethylene with vinyl acetate, of (meth)acrylic esters of (meth)acrylic acid and of an alcohol having from 1 to 24, and advantageously 1 to 9, carbon atoms.

The term “polyolefins” is also understood to mean blends of two or more of the abovementioned polyolefins. Ethylene/alkyl (meth)acrylate copolymers may be more particularly used as olefin copolymer according to the invention, it being possible for the alkyls to have up to 24 carbon atoms, and preferably 10 carbon atoms, and to be linear, branched or cyclic.

Examples of alkyl acrylates or methacrylates are preferably methyl methacrylate, methyl acrylate, ethyl methacrylate, ethyl acrylate, n-butyl acrylate, isobutyl acrylate, 2-ethylhexyl acrylate and cyclohexyl acrylate.

Among these (meth)acrylates, methyl acrylate, ethyl acrylate and n-butyl acrylate are preferred.

Advantageously, these copolymers comprise from 2 to 40%, and preferably 3 to 35%, by weight of alkyl (meth)acrylate. Their MFI (melt flow index) is advantageously between 0.1 and 50 g/10 min (measured at 190° C. and at a load of 2.16 kg according to ASTM D 1238). Their weight-average molecular weight M_{w} is preferably equal to 30 000 or higher. These copolymers may be manufactured by high-pressure autoclave or tube radical polymerization.

According to a preferred embodiment of the invention, these compositions are obtained by compounding, preferably by extrusion, in the form of masterbatches. These may preferably have organophilic filler contents of at least 20%, and ranging up to about 90%, by weight.

The term “nanofillers” thus denotes particles of any shape having at least one of their dimensions of the order of one nanometer. Advantageously, these are lamellar exfoliable fillers. In particular, the lamellar exfoliable fillers are silicates and especially organophilic treated clays. These clays, which are in the form of sheets, are rendered organophilic by intercalation between them of swelling agents, which are organic molecules or polymers, and are obtained in particular using the process as described in patent US 5 578 672. Preferably, the clays used are of the smectite type, either of natural origin, such as in particular montmorillonites, bentonites, saponites, hectorites, fluorohectorites, beidellites, stibensites, nontronites, stipulgites, attapulgites, illites, vermiculites, halloysites, stevensites, zeolites, diatomaceous earths and mica, or of synthetic origin, such as permutites.

For example, mention may be made of the organophilic clays described in patent US 6 11 7 932.

Preferably, the clay is modified by an organic substance by ionic bonding with an onium ion having 6 or more carbon atoms. If the number of carbon atoms is less than 6, the organic onium ion is too hydrophilic and therefore the compatibility with the olefin copolymer may decrease. Examples of organic onion ions that may be mentioned include: hexylammonium ions, octylammonium ions, 2-ethylhexylammonium ions, dodecylammonium ions, laurylammonium ions, octadecylammonium (stearylammonium) ions, dioctyldimethylammonium ions, trioctyl-ammonium ions, distearyldimethylammonium ions, stearyltrimethylammonium ions and ammonium laurate ions. Other ions may be used, such as phosphonium or sulfonium ions. Amphoteric surfactants, derivatives of aliphatic, aromatic or arylaliphatic amines, phosphines and sulfides may also be used.

It is recommended to use a clay having the highest possible area of contact with the polymer. The larger the contact area, the greater the separation between the clay lamellae. The cation exchange capacity of the clay is preferably between 50 and 200 milliequivalents per 100 g. If the capacity is less than 50, there is insufficient onium ion exchange and it may be difficult to separate the clay lamellae. On the other hand, if the capacity is greater than 200, the bonding force between the clay lamellae is so high that separation of the lamellae may be difficult. Examples of clays that may be mentioned include: smectite, montmorillonite, saponite, hectorite, beidellite, stibensite, nontronite, vermiculite, halloysite and mica. These clays may be of natural or synthetic origin. The proportion of organic onium ion is advantageously between 0.3 and 3 equivalents of the ion exchange capacity of the clay. If the proportion is less than 0.3, separation of the clay lamellae may be difficult. If the proportion is greater than 3, there may be degradation of the polymer. The proportion of organic onium ion is preferably between 0.5 and 2 equivalents of the ion exchange capacity of the clay. These organophilic clays have a high capability of being dispersed in polymeric media with a low shear rate and they modify the rheological behavior of these media. However, types of lamellae fillers, such as zirconium or titanium phosphates, may be used according to the invention.

Another subject of the invention is the use of the compositions according to the invention in the form of masterbatches, the introduction of which into thermoplastic olefin resins such as polyethylene or polypropylene, by extrusion, gives them improved thermomechanical properties, intrinsic to what are called “nanocomposite” filled resins. Preferably, the thermoplastic resin is a polyethylene chosen from the group comprising high-density polyethylene, low-density polyethylene, linear lower-density polyethylene, very low-density polyethylene and polyethylene obtained by metallocene catalysis. However, other types of polyolefins, such as those described above, and especially alpha-olefin homopolymers or copolymers, are also suitable.

The Applicant has found that parts or articles obtained by injection-molding such a nanofilled thermoplastic resin exhibit mechanical properties, such as the dynamic elastic modulus or the tensile modulus, which are substantially improved over those of the thermoplastic resin with no additive.

Furthermore, the materials obtained from the thermoplastic resin compositions according to the invention exhibit high barrier properties with respect to fluids, that is to say a reduced permeability to said fluids, which may be gases or liquids. These materials, hereafter called barrier materials, may be used in particular in the field of food packaging and in the field of transporting and storing liquids, such as solvents or hydrocarbons. Among the gases to which the barrier materials present a low permeability, mention may especially be made of oxygen, carbon dioxide and water vapor. Such an oxygen/carbon dioxide barrier material is of considerable interest for applications in the packaging field, especially for packaging food.

As liquids to which the material has to be impermeable, mention may be made of hydrocarbon compounds, such as solvents or gasoline(s), and one advantageous application of said materials is in the automobile field, in particular from a manufacture of fuel tanks or fuel supply tubing.

### Exemplary Embodiments of the Invention

Raw materials used:

LOTRYL® 29MA03, an ethylene copolymer containing.29% methyl acrylate by weight, with an MFI of3 g/10 min (measured at 190° C./2.16 kg according to ASTM D 1238);

LOTRYL® 28MA07, an ethylene copolymer containing 28% methyl acrylate by weight, with an MFI of 7 g/10 min (measured at 190° C./2.16 kg according to ASTM D 1238);

LOTRYL® 9MA02, an ethylene copolymer containing 9% methyl acrylate by weight, with an MFI of 2 g/10 min (measured at 190° C./2.16 kg according to ASTM D 1238); and

LACQTENE® 2040ML55, a high-density polyethylene (HDPE, injection-molding grade), having a density of 0.955 and an MFI of 4g/10 min (measured at 190° C./2.16 kg according to ASTM D 1238);

these four polymers being produced by Atofina.

Organofillic fillers:

NANOMER® 13.0P clay (montmorillonite intercalated by octadecylamine (25-35% by weight));

NANOMER® 1.44PA clay (montmorillonite intercalated by dimethyl dialkyl (C₁₄-C₁₈) ammonia (30-40% by weight));

NANOMER®1.31PS clay (montmorillonite intercalated by octadecylamine (15-35% by weight) and y-aminopropolytriethoxysilane (0.5-5% by weight)),

all three being produced by Nanocor; and

nanocomposite PE masterbatch: NANOMER® C.30PE (LDPE and montmorillonite (maximum content 50% by weight)) from Nanocor.

Apparatus:

Internal mixer of the MEILI type;

Corotatina twin-screw extruder of the HAAKE 16 type.

Analysis:

Ash content: obtained by direct calcination, that is to say by burning the organic substance and treating the residue at a temperature of 600° C. until a constant mass is obtained. We will distinguish the filler content corresponding to the amount of material (organophilic clays in powder form or masterbatch in granule form) incorporated into the masterbatch and the ash content corresponding to the mineral composition of the nanocomposite (equivalent to the mineral part of the clay);

Transmission electron microscopy (TEM): the micrographs are obtained using an apparatus of the ZEISS CEM 902 type on specimen sections produced by low-temperature ultramicrotomy;

Gas (O₂/CO₂) permeability: permeability measurement for the purpose of determining the gas flux (in cm³) that can diffuse over 1 day through a.membrane of given area. The flux is expressed in cc/m². 24 h. This measurement is carried out on an apparatus of the LISSY GPM 500 type (chromatography detection) on 150 to 250 μm films obtained by compression molding on a Darragon press (220° C./100 bar maximum); and

Water vapor (H₂O) permeability: measured using a gravimetric method on 150 to 250 μm films obtained by compression molding on a Darragon press (220° C./100 bar maximum). The purpose of the measurement is to determine the mass of water vapor (in g) that can diffuse through a membrane of given area (in m²) over 1 day (ASTM E96 and NF ISO 2528 (August 1989) standards).

### EXAMPLES 1, 2 AND 3

The first three tests were obtained by the extrusion of LOTRYL® 29MA03 in the presence of the fillers NANOMER® 1.30P, NANOMER® I.44PA and NANOMER® I.3.1PS, respectively. This operation was carried out in two steps: coarse introduction of the clay into the LOTRYL® copolymer matrix by means of the internal mixer at 100° C. (material temperature: 110 to 150° C.) for 15 minutes followed by granulation and extrusion of the precompound in the twin-screw extruder at a temperature of 180° C. (flat temperature profile) at 60 rpm (residence time around 2 minutes) so as to improve the exfoliation and the dispersion of the fillers. The content of organophilic clay introduced was 20% by weight of the compound.

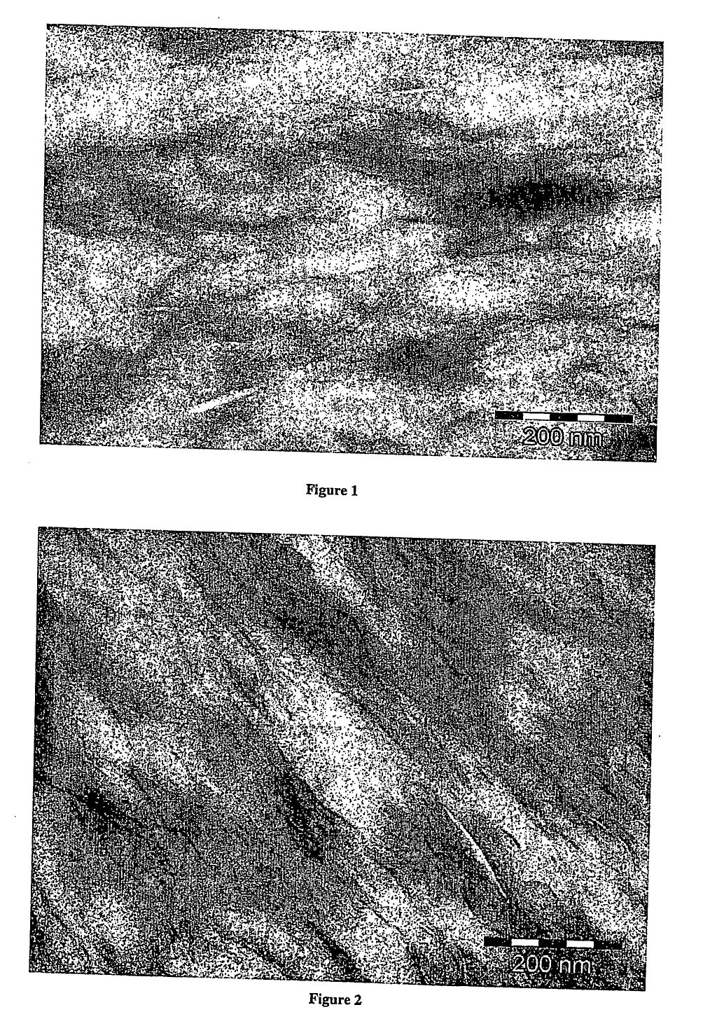

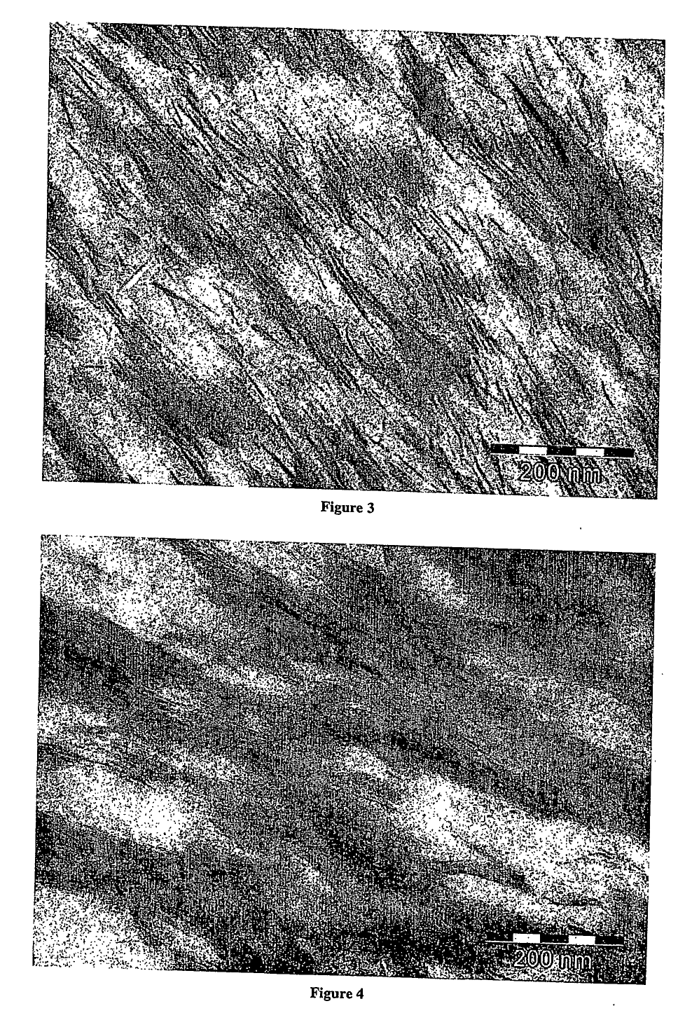

The compound obtained was analyzed by TEM, the micrographs obtained being shown in FIGS. 1, 2 and 3. Examination of these micrographs reveals the perfect state of exfoliation of the clay sheets and their good dispersion (preferably in the case of NANOMER® I.44PA and NANOMER® I..31PS).

### EXAMPLE 4

A LOTRYL® 29MA03/NANOMER® I.31PS masterbatch having an organophilic filler content of 50% by weight was also produced according to the procedure described in Examples 1 to 3. The ash content measured was 27.6%, corresponding to an effective treated-clay filler content of 42.4%.

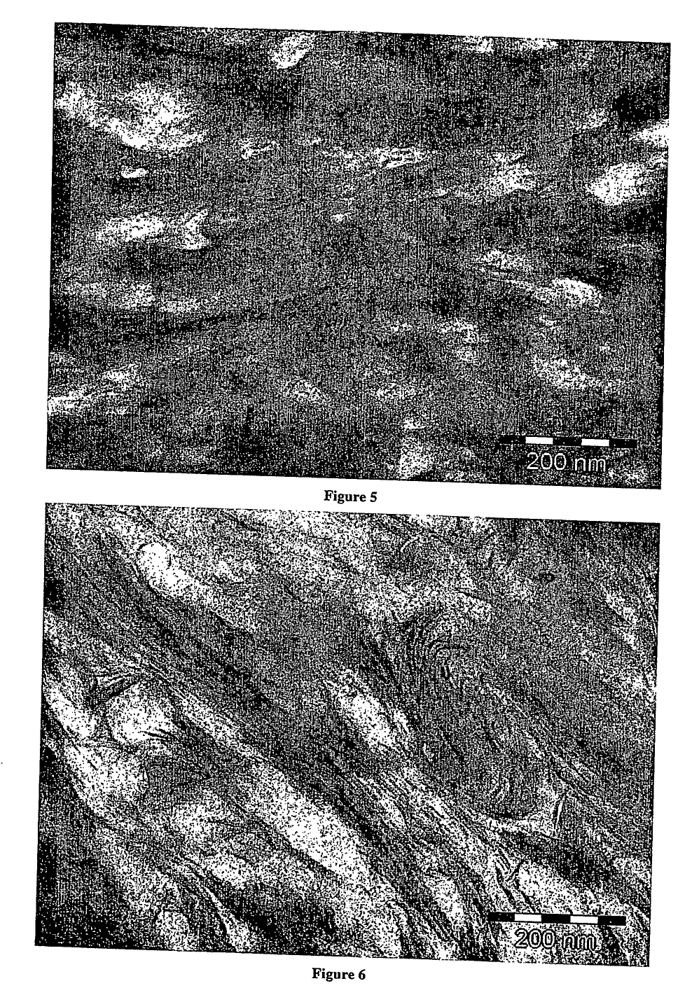

The TEM micrograph obtained is given in FIG. 4 and shows good exfoliation of the clay and uniform distribution of the filler.

### EXAMPLES 5 AND 6

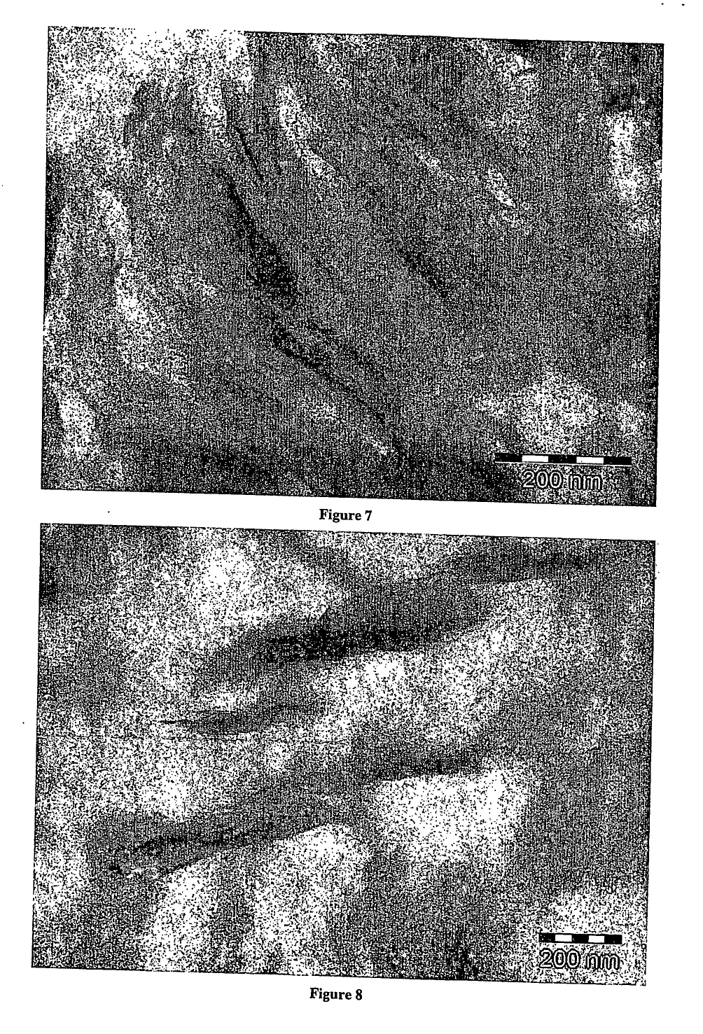

Two other masterbatches were prepared by introducing 50% by weight of NANOMER® 144PA clay using the same procedure as in the case of Examples 1 to 4 with LOTRYL® 9MA02 and LOTRYL® 28MA07, respectively. The respective measured ash contents were 30.3% and 30.2%, corresponding to effective treated-clay filler contents of 47.5% and 47.3%, respectively. Examination of the TEM micrographs given in FIGS. 5 and 6, respectively, shows good intercalation, and better exfoliation of the clay within the LOTRYL-based masterbatch than in a commercial masterbatch based on NANOMER® C.30PE-type polyethylene (FIG. 7). The XR diffractograms show an increase in the inter-sheet distance from 25.2 Å in the case of NANOMER® I.44PA to 36.73 Å and 45 Å, respectively, for the LOTRYL®-based masterbatches, whereas the XR diffractogram corresponding to the LDPE-based masterbatch shows only a signal at 22-24 Å, which clearly demonstrates much greater intercalation by the polymer between the clay sheets in the case of LOTRYL®.

### EXAMPLES 7, 8 AND COMPARATIVE EXAMPLE 9

The filled materials corresponding to Examples 7 to 9 were prepared, respectively, by incorporating 12% by weight -of the masterbatches of Examples 5 and 6, or of a polyethylene (NANOMER® C.30PE)-based masterbatch, into a LACQTENE® 2040ML55 (HDPE). This incorporation was carried out using a HAAKE 16-type twin-screw extruder at a temperature of 200° C. (material temperature varying from 210 to 235° C.), with a screw rotation speed of 120 rpm and a material throughput of 500 g/h. The HDPE and the various masterbatches were introduced at a single feed in the form of a dry blend.

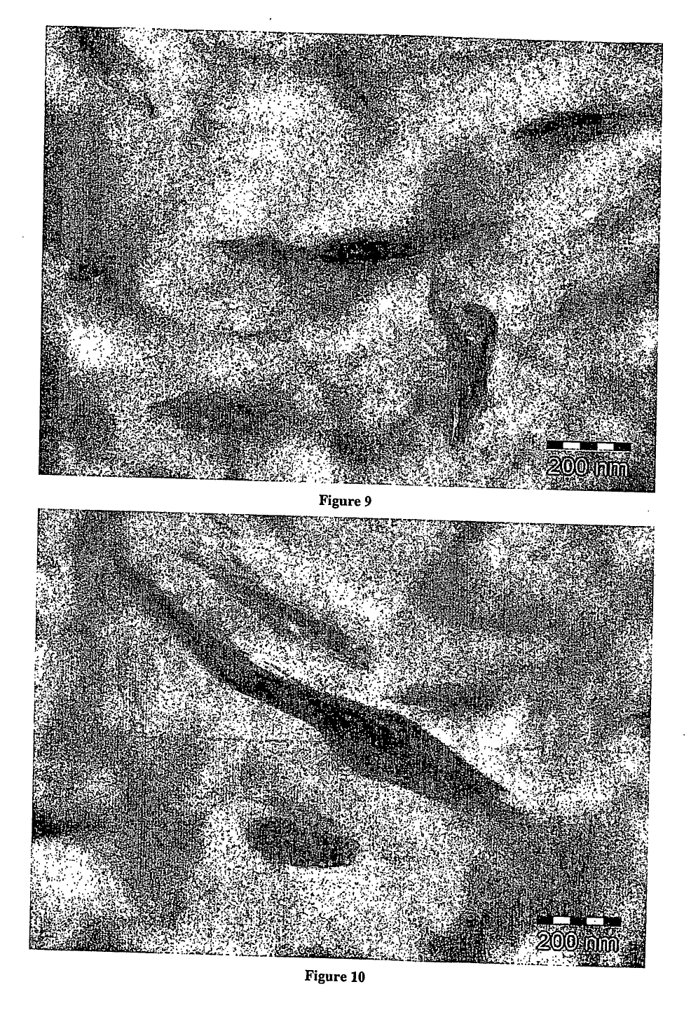

FIGS. 8 to 10, which show the TEM micrographs at moderate magnification (50 000 times) of the various HDPE-based materials (corresponding to Examples 7 and 8 and to Comparative Example 9, respectively), reveal a substantially finer state of dispersion of the fillers (disintegration of the clay lumps) in the first two cases (use of the LOTRYL®-based masterbatches).

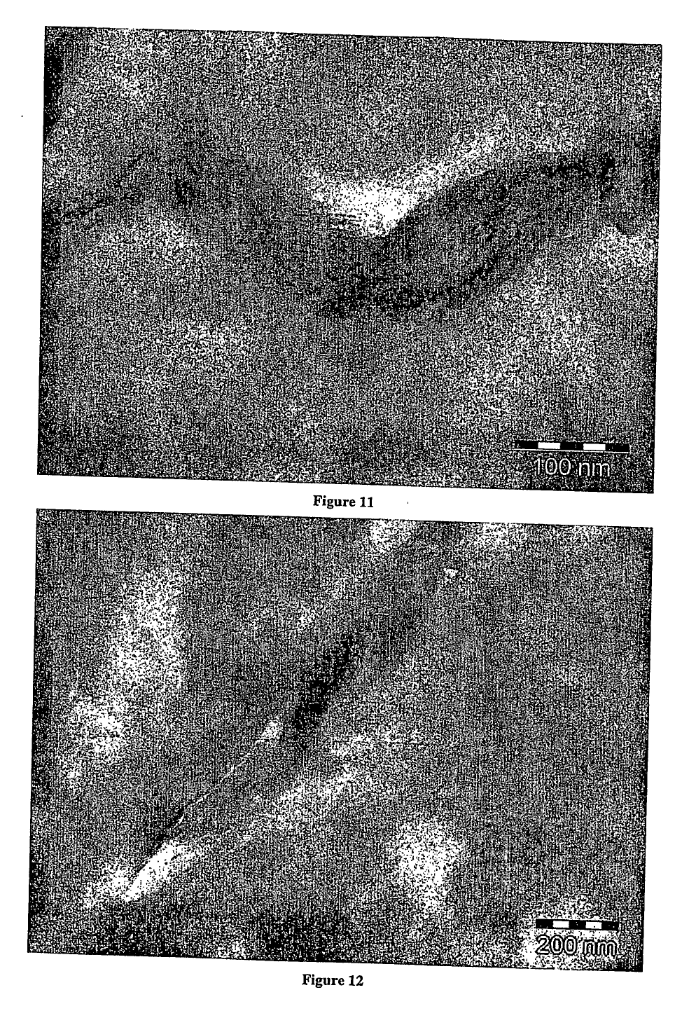

The TEM micrograph at a higher magnification (140 000 times) of Example 8, shown in FIG. 11, and the results of the XR analysis (inter-sheet distance of around 40 Å) clearly demonstrate that a nanocomposite is obtained with intercalation of the polymer matrix within the interlamellar space. In the case of the HDPE-based masterbatch, analysis of the XR diffractograms of the composite of Example 9 shows a very small broadening of the interlamellar distance (26.3 A) compared with the NANOMER® C.30PE masterbatch (24 Å), corresponding to the small degree of intercalation by the PE matrix.

### COMPARATIVE EXAMPLE 10

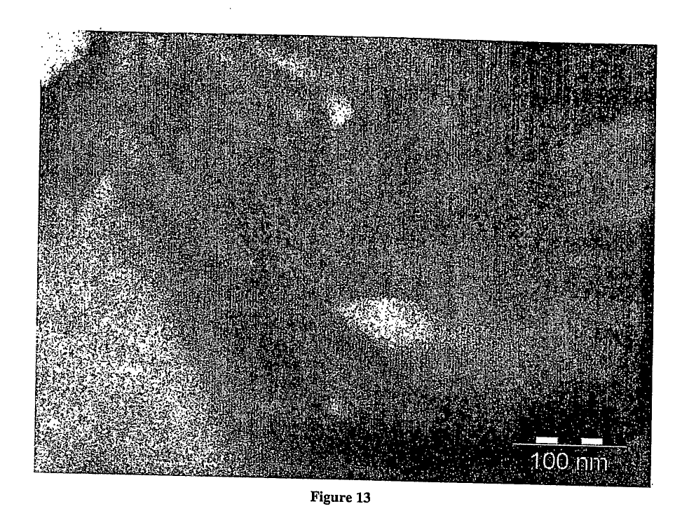

Direct introduction of 6% NANOMER® 144PA organophilic clay into the same HDPE, with the LACQTENE® 2040ML55 reference, under the same operating conditions as those described in Examples 6 to 8, resulted in a product in which there was no intercalation of the clay, as shown by the TEM micrographs (140 000 x magnification) of FIGS. 12 and 13. This absence of intercalation was also confirmed by analyzing the XR diffractograms of the composite material of Comparative Example 10 and of the pure NANOMER® 144PA clay. The difference in distance between clay sheets for each of the two compounds was not significant: 25.2 Å in the case of NANOMER® 144Pa and 26.6 Å in the case of Example 10.

### COMPARATIVE EXAMPLES 11, 12 AND 13

Comparative Example 11 corresponds to HDPE alone (LACQTENE® 2040ML55) and Comparative Examples 12 and 13 correspond to the respective compound of 6% by weight of LOTRYL® 9MA02 and LOTRYL® 28MA07 in this same HDPE. These three products were also extruded under the same operating conditions as those described in Examples 7 to 10.

To evaluate the barrier properties of the compounds of Example 7 and of Comparative Examples 11 and 12, tests were carried out on 150 μm thick films prepared by compression molding, so as to determine the permeability to gases H₂O, O₂ and CO₂. The results are indicated in Table 1 below. It will be noted that the addition of a small amount of LOTRYL (amorphous PE) results in an increase in the permeability (Ex. 12 compared with Ex. 11). The change in permeability is with reference to the corresponding control specimen, namely Ex. 11 in the case of Ex. 10 and Ex. 12 in the case of Ex. 7. It should be noted that there is a significant increase in impermeability (⅓ change) in the case in which the clay is introduced in the form of a LOTRYL®-based masterbatch. The better dispersion of the fillers within the material, obtained by using the LOTRYL® masterbatch, leads to better results in terms of impermeability.

TABLE 1

| | Comp. | Comp. | Comp. | |
|---|---|---|---|---|
| | Ex. 11 | Ex. 12 | Ex 10 | Ex. 7 |
| LACQTENE 2040ML55 | 100 | 94 | 94 | 88 |
| MM Ex. 5 | | | | 12 |
| NANOMER ® I44PA | | | 6 | |
| LOTRYL ® 9MA02 | | 6 | | |
| Stabilizer (ppm) | 1500 | 1500 | 1500 | 1500 |
| H₂O flux | 1.5 | 2.0 | 1.2 | 1.3 |
| (g · 150 μm/ | | | | |
| m² · 24 h) | | | | |
| Reduction in | — | — | −20% | −35% |
| permeability | | | (Ex. 11) | (Ex. 12) |
| (relative to) | | | | −13% |
| | | | | (Ex. 11) |
| O₂ flux | 390 | 397 | 325 | 287 |
| (cc · 150 μm/ | | | | |
| m² · 24 h · atm) | | | | |
| Reduction in | | | −17% | −28% |
| permeability | | | (Ex. 11) | (Ex. 12) |
| (relative to) | | | | −26% |
| | | | | (Ex. 11) |
| CO₂ flux | 1468 | 1655 | 1175 | 1127 |
| (cc · 150 μm/ | | | | |
| m² · 24 h/atm) | | | | |
| Reduction in | — | — | −20% | −32% |
| permeability | | | (Ex. 11) | (Ex. 12) |
| (relative to) | | | | −23% |
| | | | | (Ex. 11) |

1. A thermoplastic polymer composition in the form of a masterbatch, comprising a matrix consisting of an olefin copolymer, obtained from at least one olefin monomer and from at least one alkyl (meth)acrylate monomer, in which matrix exfoliable organophilic fillers of the lamellar type are dispersed, wherein said fillers, after complete dispersion, are of nanoscale size and comprise at least 20% by weight relative to the composition.

2. The thermoplastic polymer composition as claimed in claim 1, wherein the olefin copolymer comprises:
60 to 98% by weight of olefin comonomer; and
2 to 40% by weight of alkyl (meth)acrylate comonomer.

3. The composition as claimed in claim 1, wherein the olefin comonomer is a homopolymer or copolymer of ethylene or of an alpha-olefin.

4. The composition claim 1, wherein the alkyl (meth)acrylate comonomer is methyl acrylate, ethyl acrylate, n-butyl acrylate or 2-ethylhexyl acrylate.

5. The composition as claimed in claim 1, wherein the organophilic filler comprises clays of the smectite type, treated with a swelling agent.

6-7. (canceled)

8. The thermoplastic polymer composition of claim 1 wherein said exfoliable organophilic fillers of the lamellar type comprises a silicate.

9. The composition as claimed in claim 3, wherein the olefin comonomer is a homopolymer or copolymer of an alpha-olefin having from 3 to 30 carbon atoms.

10. The composition as claimed in claim 5, wherein said montmorillonite is selected from the group consisting of nontronites, beidellites, hectorites and bentonites.

11. A nanocomposite comprising:
a) a masterbatch, comprising a matrix consisting of an olefin copolymer, obtained from at least one olefin monomer and from at least one alkyl (meth)acrylate monomer, in which matrix exfoliable organophilic fillers of the lamellar type are dispersed, wherein said fillers, after complete dispersion, are of nanoscale size and comprise at least 20% by weight relative to the composition; and
b) a thermoplastic polymer,
wherein said nanocomposite is formed by the blending and extrusion of said masterbatch with said thermoplastic polymer.

12. The nanocomposite of claim 11 wherein said thermoplastic resin is a polyethylene selected from the group consisting of high-density polyethylene, low-density polyethylene, linear low-density polyethylene, very low-density polyethylene and polyethylene obtained by metallocene catalysis.
